(19) United States
(12) Patent Application Publication
(10) Pub. No.: US 2026/0292054 A1
(43) Pub. Date: Sep. 24, 2026

(54) COMMUNICATIONS ADAPTER FOR DETECTION DEVICE AND COMMUNICATIONS METHOD FOR A DETECTION DEVICE

(71) Applicant: SMITHS DETECTION-WATFORD LIMITED, Hemel Hempstead (GB)

(72) Inventors: Maximilian Oliver MCDOUGALL, Hemel Hempstead (GB); Jonathan PARNELL, Hemel Hempstead (GB)

(21) Appl. No.: 19/475,702

(22) PCT Filed: Apr. 19, 2024
(86) PCT No.: PCT/GB2024/051032

§ 371 Date: Oct. 15, 2025

(30) Foreign Application Priority Data
Apr. 19, 2023 (GB) 2305774.8
May 22, 2023 (GB) 2307618.5

(51) Int. Cl. H04M 1/72412; H04M 1/04

(52) U.S. Cl. CPC H04M 1/72412; H04M 1/04

(57) ABSTRACT

An aspect of the disclosure provides A communications adapter for a detection device, the adapter comprising: a housing; a wireless communications interface disposed in the housing; an attachment mechanism, engageable with the detection device to removably attach the housing to the detection device; and a signal connector, configured to connect to a wired communication interface of the detection device; wherein the signal connector is positioned relative to the attachment mechanism such that engaging the attachment mechanism with the detection device connects the signal connector to the wired communication interface of the detection device.

### FIELD OF INVENTION

The present invention relates to methods and apparatus and more particularly to detection devices for detecting substances such as chemicals and biological agents and other threats. Still more particularly the disclosure relates to a communications adapter for such devices and to communications methods.

### BACKGROUND

Personnel often operate in environments in which unknown and potentially hazardous substances may be present. A variety of techniques exist for detecting such substances and identifying whether they represent a threat. One such technique is ion mobility spectrometry (IMS). Some devices provide detection of radiation sources and may provide detection of radiological threats by measuring dose rate and accumulated dose of ionising radiation such as gamma radiation. Specially adapted photodetectors may be provided for this purpose. Other types of detection devices may also be used, including mass spectrometers and Raman spectroscopy devices and other types of system. The vital safety role played by these devices means that reliability of operation is a key issue.

Human portable detection devices, such as wearable and handheld detectors are increasingly prevalent. Many security organisations, such as the military, demand rugged and reliable human portable detection devices.

Embodiments of the present disclosure aim to address these and other technical problems.

### SUMMARY

Aspects and examples of the present disclosure are set out in the claims.

### BRIEF DESCRIPTION OF DRAWINGS

Embodiments of the disclosure will now be described in detail with reference to the accompanying drawings, in which:

FIG. 1 shows a front view and a side view of a detection device having a communications adapter attached to it;

FIG. 2 shows an isometric view of the communications adapter shown in FIG. 1;

FIG. 3 is an exploded view of the communications adapter shown in FIG. 2;

FIG. 4 shows a partially cut away view of the detection device with attached communications adapter and in this view the underside of the detection device is visible and a housing of the communications adapter is partially cut away to show the fitting of the adapter onto the communications device;

FIG. 5 is a section view of the arrangement shown in FIG. 4; and

FIG. 6 shows a diagram of a system comprising apparatus such as that illustrated in FIG. 1, a UE and a remote communications device.

In the drawings like reference numerals are used to indicate like elements.

### SPECIFIC DESCRIPTION

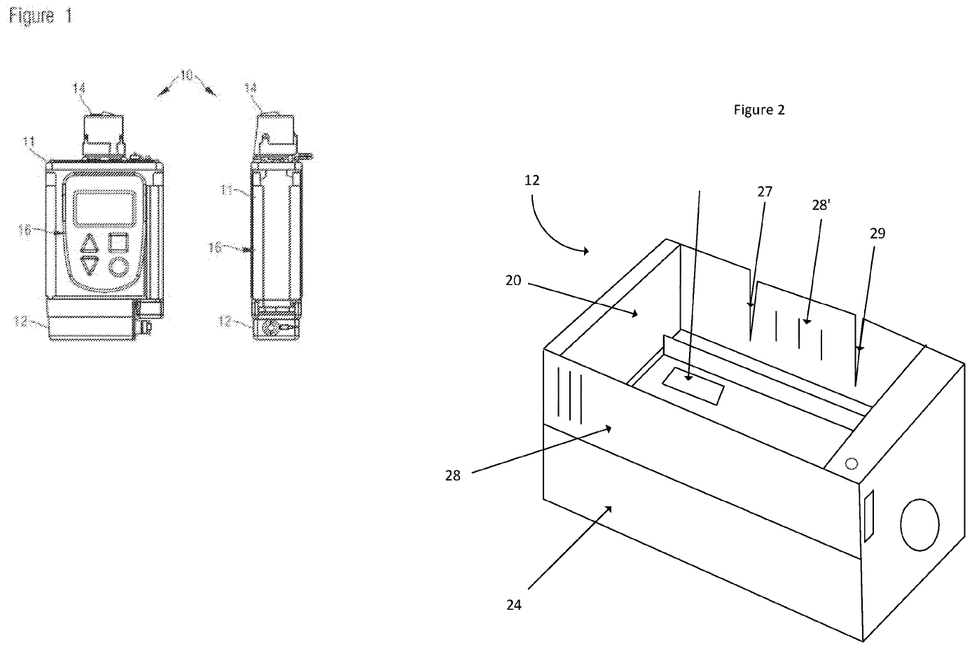

FIG. 1 shows a detection device 10 and a communications adapter 12 attached to that device 10.

As illustrated the detection device 10 may comprise an inlet 14 for collecting samples to be tested for the presence of substances of interest. The inlet 14 may be disposed at one end of the detection device 10. The detection device 10 typically includes a human operable user interface 16 for controlling the detection device 10 and for providing information to the human operator indicating the results of testing, for example the user interface 16 may comprise a display. This user interface 16 may be provided on a different part of the device 10 from the inlet 14, such as its front face. The communications adapter 12 may be attached to the other end of the detection device 10 from the inlet 14.

The detection device 10 is typically a human portable device configured to be hand-held or wearable by a single human. Such a device 10 may comprise an ion mobility spectrometer, such as a time-of-flight ion mobility spectrometer. Other types of human portable detection devices may also be used.

Whatever the type of detection device 10, it is typically configured to produce detection data indicating the results of detection tests-which may provide an indication of the presence or absence of a substance of interest in a sample that is provided to the inlet 14 of the device. Such samples may be indicative of substances in the vicinity of the device, such as airborne substances. For example, the device may inhale a flow of air through the inlet 14. The device may also comprise heating means to volatilise substances provided to the inlet 14, whether in a flow of air or carried by a sampling probe, such as by a swab.

The detection device 10 illustrated in FIG. 1 has a substantially rectangular cuboid body 11, the inlet 14 being disposed at one end of that body 11. The other end of the body 11 may carry a protrusion—such as a protrusion 40 associated with a sieve pack module of the detection device 10. It may also carry an element for the installation and/or removal and/or charging of a battery pack of the detection device 10.

A wired communications interface of the detection device 10 may be provided by a connector such as a shielded multi-pin connector which may be a micro-D or other D-sub type connector. This signal connector is typically of a plug or socket and configured to connect to complementary plug or socket connector. This connector on the outside of the detection device 10 may be provided at the opposite end of the detection device 10 from the inlet 14 and may face away from the end of the body 11. This connector may be disposed adjacent to the protrusion 40 mentioned above.

The communications adapter 12 may be secured to this end of the device, opposite to the inlet 14. When the communications adapter 12 is secured to the device, the protrusion 40 associated with the sieve pack may be seated in a recess 20 of the communications adapter 12.

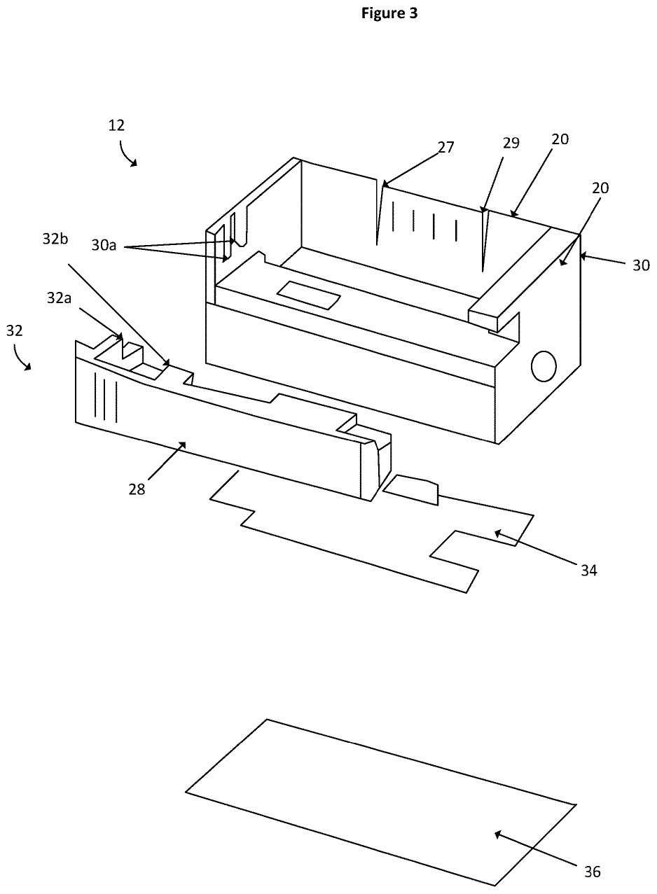

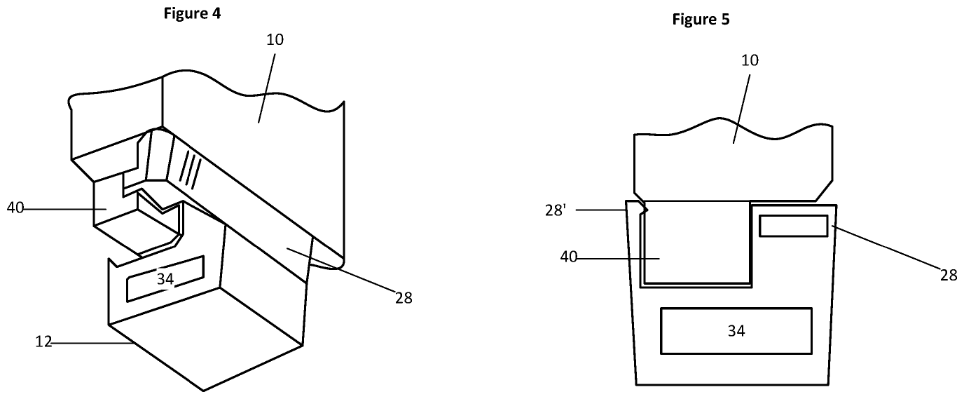

FIG. 2 shows the communications adapter 12 in greater detail. FIG. 3 shows an exploded view of the communications adapter 12. FIG. 4 and FIG. 5 show close up views of the adapter 12 when connected to the detection device 10.

As shown best in FIG. 2 the communications adapter 12 provides a substantially cuboid shaped body 24. This body 24 is made up of a housing 30 comprising an obround recess 20 in the top of the housing 30 toward its rear. In the top of the housing 30, adjacent this recess 20 is a connector 22 for making a wired signal connection. As illustrated the connector 22 comprises a shielded multi-pin connector such as a D-sub connector. Adjacent the connector 22, along the front edge of the housing is an elongate member 28, which may be hinged at one end and comprise a releasable clip 32 at the other. The clip 32 may comprise a resilient detent for engagement with a corresponding feature of the housing 30. For example, the clip 32 carries a first engagement feature 32A, which may be a protrusion such as a “nipple”. This feature 32A is provided at the opposite end of the elongate member 28 from its hinge. The housing 30 comprises second engagement features 30A, such as two adjacent recesses, configured to hold the first engagement feature in one of two selected positions—a latched position and an unlatched position. The elongate member 28 is operable to pivot about its hinge to move the first engagement feature between these teow positions. The first engagement feature may be resiliently deformable so it can “pop” between the two positions defined by the second engagement features 30A.

This elongate member 28 may thus provide a releasable latch at the front upper edge of the housing 30 as described below. When the clip 32, 32A is in the unlatched position the adapter 12 can be removed from the detection device 10.

The elongate member 28 also carries a lateral arm 32B which extends out from the elongate member 28, inwardly into the housing 30 and into the base of the recess 20. When the adapter 12 is attached to a detection device 10, a protrusion 40 on the base of the detection device 10 is seated in the recess 20. When the clip 32, 32A is in the latched position the lateral arm 32B engages with this protrusion 40. The action of this lateral arm 32B and the rear snap fit 28′ (described below) cooperate to hold the adapter 12 to the detection device 10 (e.g. to provide “long-axis” retention).

Encapsulated in the housing 30, beneath the signal connector 22 is a PCB 34 which carries a data processor for performing data processing functions, such as encryption and protocol transformation. Typically, the PCB 34 is disposed parallel to the base 36 of the housing 30, e.g. seated in the base 36 of the housing 30 so that it is aligned with a base of the detection device 10.

The PCB 34 carries hardware to provide at least one communications interface, such as a short range wireless communications interface—such as bluetooth. It may also carry hardware for a wired communications interface such as a serial bus, e.g. a universal serial bus USB or similar. The PCB comprises connections for connecting the data processor to the signal connector for obtaining detection signals from the detection device 10. The data processor is configured to provide the detection signals to the wireless communications interface for transmission and optionally also to the wired communications interface.

The data processor is configured to transform the detection signals from a first data format associated with the wired communication interface of the detection device 10 into a second protocol, different from the first communications protocol used by the detection device 10. The data processor is configured to use this second communications protocol for forwarding the detection signals via the wireless communications interface. The detection signals may also be forwarded via the wired communication interface of the adapter. It will be appreciated that the wired communication interface of the adapter may operate using a third communications protocol, which may be different from the first and second communications protocols.

The signal connector 22 on the top of the housing 30 is typically of a plug or socket type and configured to connect to the complementary connector of a wired communication interface of the detection device 10. The connector 22 may have an end face which carries a plurality of pins or a plurality of cylinders for receiving such pins. It may be configured so that these pins or cylinders and a side surface of the connector are mutually aligned with each other in a first direction, which may be perpendicular to the end face of the connector and optionally also with the end face of the detector. The wired signal connectors of the adapter and detection device 10 are thus configured to be connected to each other by movement in this first direction.

As noted above a recess 20 is provided in the communications adapter 12, adjacent to the signal connector. The recess 20 is configured so that a protrusion 40 on the base of the detection device 10 can be seated in the recess 20. Typically, the recess 20 is larger (laterally) and also deeper than the signal connector. The internal side walls of the recess 20 may be configured to fit the edges of the protrusion 40 on the detection device 10 so that by sliding the protrusion 40 into the recess 20, the signal connector on the adapter can be aligned with the signal connector on the detection device 10. Embodiments thus provide a rugged and easily operated design—capable of being reliably operated even by personnel wearing protective equipment and/or gloves which may be cumbersome. The top of the communications adapter 12 housing also carries an attachment mechanism, configured to engage with the detection device 10 to removably attach the housing to the detection device 10. As illustrated, this may be provided by a snap-fit at a rear edge of the top of the housing. The attachment mechanism may also comprise a retaining latch, which may be provided at a front edge of the top of the housing. The attachment mechanism is configured to engage with the detection device 10 by pushing the housing towards the detection device 10 in the first direction. It may be guided in this movement by the protrusion 40 (e.g., the sieve pack module) of the detection device 10 fitting, as described above, into the recess 20 on the adapter.

The attachment mechanism 28, 28′ may comprise a snap-fit clip 28′ which may be provided by a wall of the rear edge of the housing 30 having a deflectable portion and carrying an engagement feature, such as a detent, which may be provided by a groove or ridge. The engagement feature is configured to engage with a complementary feature of the detection device 10, such as the sieve pack cover. The deflectable portion may be resilient. The wall of the housing 30 may be configured to allow deflection of the deflectable portion, for example it may comprise slots 27, 29 either side of the deflectable portion.

In operation, to attach the communications adapter 12 to the detection device 10, the operator may first ensure that the elongate member 28 and the clip 32, 32A is in the unlatched position (e.g. displaced outwards from the centreline of the assembly). Then they can align the protrusion 40 of the detection device 10 with the recess 20 of the communications adapter 12 and then push the two together in the first direction. The detection device 10 may thus come into contact with the deflectable portion of the attachment mechanism and cause it to be deflected in a second direction, perpendicular to the first direction, e.g., outwardly.

As the engagement feature of the deflectable portion 28′ engages with a complementary feature of the detection device 10, the deflectable portion is able to move inwardly again as the two “snap-fit” together. Specifically, the deflectable portion 28′ is deflected by the protrusion 40 (such as the sieve pack cover of the device 10). When the device 10 is fully seated in the adapter, the engagement feature of the deflectable portion 28′ latches with the protrusion 40. This may provide audible and/or haptic feedback indicating positive engagement of the adapter with the detection device 10.

The elongate member 28 should be pushed towards the centreline of the assembly, thus moving the clip 32, 32A into the latched position and the lateral arm 32B into the recess 20 so it can engage a surface of the protrusion 40 in the recess (such as the sieve pack cover).

With the communications adapter 12 in this position, with the attachment mechanism fully engaged, the clip 32, 32A in the latched position, and the protrusion 40 of the detection device 10 seated in the recess 20 of the communications adapter 12, the communications adapter 12 is restrained so as to inhibit (for example, substantially to prevent) relative movement in any direction perpendicular to the first direction. The resilient nature of the connection provided by the attachment mechanism and the clip 32, 32A may together make this connection resistant to mechanical shocks such as those associated with dropping the device and may serve to prevent damage to the wired signal connections.

As noted above, the attachment mechanism may comprise a retaining latch which can be used to release the communications adapter 12 from the detection device 10.

For example, the retaining latch may be operable to disengage the attachment mechanism from the detection device 10. For example, it may comprise an elongate member which provides one edge of the top of housing. The elongate member may have an outward facing surface, which forms part of the external surface of the housing and an inward facing surface configured to engage with the external surface of the detection device 10. One end of the elongate member may be pivotably coupled to the housing, for example by a pin or otherwise arranged to provide a hinge. The other end of the elongate member may comprise a clip to releasably hold that end of the elongate member to the housing. To release the attachment mechanism from the detection device 10, the clip may be disengaged to allow the elongate member to pivot outward.

The signal connector and the attachment mechanism are positioned relative to each other on the top surface of the communications adapter 12 such that engaging the attachment mechanism with the detection device 10 also connects the signal connector to the wired communication interface of the detection device 10. The attachment mechanism may be configured so that the fully engaged (attached) position of the attachment mechanism corresponds to a position in which the signal connector of the communications adapter 12 is fully connected to the wired communications interface of the detection device 10.

The communications adapter 12 also carries a wireless communications interface for short range wireless communications. AT least some of the hardware for this interface is carried by the PCB. Where necessary, an antenna may also be provided in the housing. Typically, the range of this wireless interface may be about 20 m or less, for example 10 m. The wireless communications interface may be configured to communicate via one or more protocols such as Bluetooth (RTM) or similar protocols operable to establish a so-called personal area network (PAN) in the vicinity of the adapter.

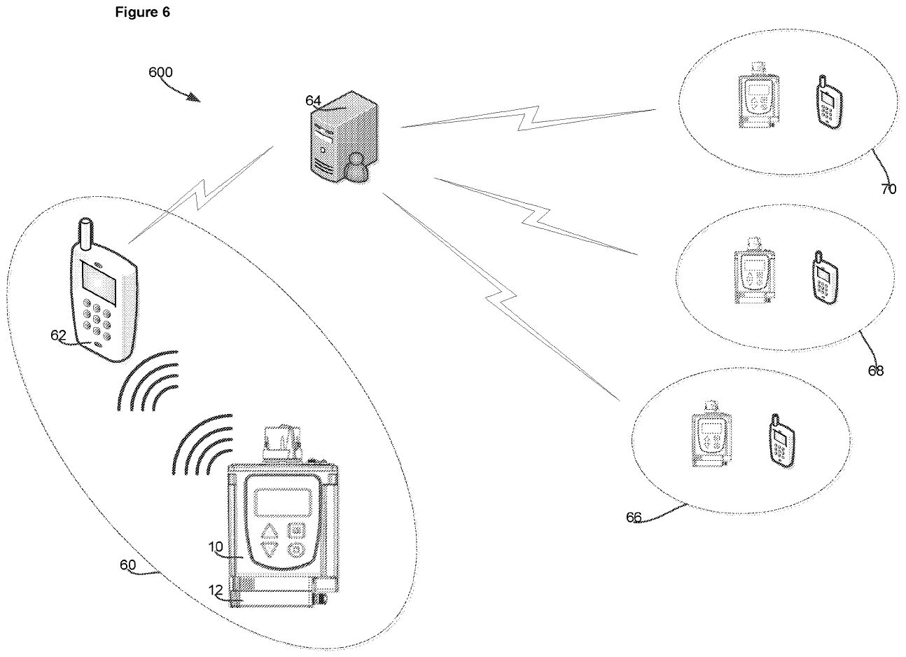

FIG. 6 illustrates a network 600. The network 600 comprises at least one system 60 made up of the communications adapter 12 and a detection device 10 and an article of so-called user equipment 62, also known as a UE, having a wide area communications interface and a UE short range wireless interface configured to communicate with the wireless communications interface of the communications adapter 12.

The network 600 may comprise a plurality of such systems 66, 68, 70 each comprising a respective detection device, communications adapter, and UE.

The network 600 also comprises a remote device 64, such as a monitoring server, configured to communicate, via the wide area communications network with the UE 62 of each system 60, 66, 68, 70 in the network 600.

In each system 60, 66, 68, 70, the communications adapter 12 is configured to communicate wirelessly with the UE 62 of that system 60 e.g. via its short range wireless interface or via a wired connection such as may be provided by the USB connector on the PCB 34. The UE 12 in turn is configured to communicate, via the wide area communication interface with the remote device 64.

In operation, the user may attach the communications adapter 12 to the detection device 10 to cause the communications adapter 12 to establish a wireless communication link with the UE and a wired connection to the detection device 10. As an alternative to wireless communication to the UE, a wired connection may be provided as noted above.

A sample is then provided to the inlet 14 of the detection device 10, which is operated to determine whether a substance of interest is present in the sample. The detection device 10 then provides via the wired connection to the communications adapter 12, detection data based on this operation.

The data processor of the communications adapter 12 then transforms the signal obtained from the detection device 10 into the appropriate data format for forwarding via the short-range link to the UE. Optionally the data is also encrypted prior to forwarding. The communications adapter 12 may include, with the forwarded data, an identifier of the detection device 10—such as a serial number or other data uniquely identifying the specific device itself.

The UE is thereby able to obtain, from the detection device 10 via the UE short range wireless interface, data based on the detection signals. This data may indicate the presence or absence of a substance of interest in the sample provide to the device. It may also comprise an indication of the detection signals themselves, such as a mobility spectrum indicating the time of arrival of ions at the detector. The UE then forwards this data to the remote device via the wide area network. The UE may include in this data, or may otherwise provide to the remote device, location data indicating the geographic location at which the detection data was obtained by the detection device 10.

The remote device may also be operable to transmit data and commands, via the wide area communications network, to the communications adapters.

Accordingly, the remote device and the communications adapters together may be configured to provide one or more of the following modes of operation:
In an embodiment, the remote device may be operable to send a command to the detection device 10, via the UE and the communications adapter 12, to trigger an alert at the detection device 10 indicating the presence of a substance of interest. This alert may be provided in response to the provision of a sample to the detection device 10 by the user. Such an arrangement may enable the systems in the network to be operated in a training mode in which circumstances, selected at the remote device, can be simulated at selected ones of the systems.
In an embodiment, the remote device may be operable to send a command to the detection device 10, via the UE and the communications adapter, to trigger an alert at the detection device 10 indicating the presence of a substance of interest at another, different, system in the network. For example the remote device may be operable to use the communications adapters to interlink the alarms between detectors, so that detection of a threat at one system triggers alerts at selected other detectors within a selected distance of the system which detected the threat. Similarly, the remote device may be operable to send a command, via the wide area network to selected systems to (a) cause those systems to perform a detection operation and/or (b) to modify operating parameters, such as detection windows and thresholds of the detection devices of those other selected systems. The command to cause operation and/or the operating parameters to be modified may be selected based on at least one of (i) the detection data received from another system and (ii) the location of a system from which such detection data was received.

The remote device may also be configured to provide remote update of firmware, detection libraries or settings to the detection device 10.

The UE of the systems described herein may be provided by any device used directly by an end-user of a wide area communications network to communicate via that network. It can be a hand-held telephone, a laptop computer or tablet, equipped with a mobile telecommunications capability such as a broadband adapter GSM, 3GPP, 4G. It can also be radio transceiver, or any other device, such as a mobile station, able to communicate via any wide area network. It will be appreciated in the context of the present disclosure that a wide area network (or WAN) may comprise systems such as telecommunications networks including cellular networks. A WAN may also comprise radio networks, such as private radio networks maintained by security entities such as military and security organisations.

In an embodiment the adapter is configured to use the protrusion 40 of the detector sieve pack cover to act as an alignment guide in the X and Y axis; navigating the user to repeatedly make the correct alignment with the signal connector in the Z-axis (referred to herein as the first direction) as they make the union between adapter and detection device.

The adapter may be configured so that as the user seats the adapter home, a slight resistance is experienced while the rear snap fit is loaded as its passes over the rear edge side of the sieve pack cover. When fully home a “click” is experienced, which acts as a haptic que for the user.

In an embodiment, the retaining latch may be pressed home from the front of the adapter, by the user's finger or thumb. This latch may also be configured to emit a “click” when fully home.

The latch and rear snap fit may together retain the adapter in the Z axis. The apparatus may be configured such that the process for removal of the adapter from the detection device is the reverse of fitment.

Mounting the adapter in this way and orienting the PCBA parallel to the underside of the detector may allow for the most compact integrated solution. In an embodiment the adapter's maximum extent is less than 20 cm, for example only 17.6 mm.

The union provided by the attachment mechanism may be robust, but without imposing significant size or mass on the user. In an embodiment the attachment mechanism provide a connection which meets or exceeds MIL-STD 810G drop and vibration levels.

Any feature of any one of the examples disclosed herein may be combined with any selected features of any of the other examples described herein. For example, features of methods may be implemented in suitably configured hardware, and the configuration of the specific hardware described herein may be employed in methods implemented using other hardware.

It will be appreciated from the discussion above that the embodiments shown in the Figures are merely exemplary, and include features which may be generalised, removed or replaced as described herein and as set out in the claims. With reference to the drawings in general, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

In some examples the functionality of the controller may be provided by a general purpose processor, which may be configured to perform a method according to any one of those described herein. In some examples the controller may comprise digital logic, such as field programmable gate arrays, FPGA, application specific integrated circuits, ASIC, a digital signal processor, DSP, or by any other appropriate hardware. In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein. The controller may comprise an analogue control circuit which provides at least a part of this control functionality. An embodiment provides an analogue control circuit configured to perform any one or more of the methods described herein.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A communications adapter for a detection device, the adapter comprising:
a housing;
a wireless communications interface disposed in the housing;
an attachment mechanism, engageable with the detection device to removably attach the housing to the detection device; and
a signal connector, configured to connect to a wired communication interface of the detection device;
wherein the signal connector is positioned relative to the attachment mechanism such that engaging the attachment mechanism with the detection device connects the signal connector to the wired communication interface of the detection device.

2. The communications adapter of claim 1 wherein the signal connector is a plug or socket configured to engage with a complementary socket or plug of the wired communication interface of the detector by movement in a first direction, wherein the attachment mechanism is configured to engage by pushing the housing against the detection device in the first direction.

3. The communications adapter of claim 2 wherein the attachment mechanism is configured to secure the adapter to the detection device to prevent relative movement in any direction perpendicular to the first direction.

4. The communications adapter of claim 1, 2 or 3 wherein the attachment mechanism comprises a retaining latch.

5. The communications adapter of any preceding claim wherein the attachment mechanism is configured to snap-fit to the detection device, for example wherein the attachment mechanism is configured to provide audible and/or haptic feedback indicating positive engagement of the adapter with the detection device.

6. The communications adapter of any preceding claim wherein the attachment mechanism is configured to align the signal connector with the wired communication interface of the detector such that pushing the adapter onto the detection device in the first direction seats the signal connector and the wired communication interface.

7. The communications adapter of any preceding claim wherein the housing comprises a recess arranged to house a component of the detection device, for example wherein the recess is configured such that seating the component in the recess aligns the signal connector for connection with the wired communication interface of the detector.

8. The communications adapter of any preceding claim wherein the housing carries a second wired communication interface on an external surface of the housing.

9. The communications adapter of claim 7 or 8 comprising a cover disposed over the second wired communication interface.

10. The communications adapter of any preceding claim wherein the adapter comprises a data processor, coupled to the signal connector for obtaining detection signals from the detection device and configured to provide the detection signals to the wireless communications interface for transmission.

11. The communications adapter of claim 10 wherein the data processor is disposed on a PCB seated in a base of the housing, aligned with a base of the detection device.

12. The communications adapter of claim 10 or 11 wherein the data processor is configured to transform the detection signals from a first data format associated with the wired communication interface into a second protocol for forwarding via the wireless communications interface.

13. The communications adapter of any of claims 10 to 12 wherein the data processor is configured to transform the detection signals from a first data format associated with the wired communication interface into a third communications protocol for forwarding via a second wired communication interface.

14. The communications adapter of claim 12 or 13 wherein the data processor is configured to encrypt the detection signals.

15. The communications adapter of any preceding claim wherein the communications adapter is configured to obtain, via the wired communications interface, an identifier of the detection device.

16. A system comprising the communications adapter of any preceding claim and a detection device for detecting a substance of interest the detection device having a wired communication interface and being configured to output data based on the detection signals via the wired communications interface to the Communications adapter.

17. The system of claim 16 further comprising user equipment, a UE having a wide area communications interface for communication via wide area network, the UE comprising:
a UE short range wireless interface configured to communicate with the wireless communications interface of the communications adapter,
the UE being configured to:
obtain, from the detection device via the UE short range wireless interface, data based on the detection signals; and
provide, to a remote device via the wide area network to transmit, an indication of the detection signals.

18. A method comprising:
operating a communications adapter, removably attached to a housing of a detection device to obtain from a wired communications interface of the detection device, detection data indicating the presence of a substance of interest at the detection device; and
providing the detection data via a short-range wireless interface to user equipment, a UE, wherein the UE is configured to provide the detection data to a remote device via a wide area network.

19. The method of claim 17 further comprising establishing a secure connection with the UE via the short-range wireless interface in the event that an attachment mechanism of the communications adapter indicates positive engagement of the communications adapter with the detection device.

20. The method of claim 18 or 19 comprising transforming the detection signals from a first data format associated with the wired communication interface into a second protocol for forwarding via the short-range wireless interface to the UE.

21. The method of any of claims 18 to 20 comprising providing, to the UE, an identifier of the detection device for example wherein the identifier is obtained from the detection device via the wired communications interface.

22. A method of operating user equipment, a UE, the method comprising:
establishing a secure connection with a communications adapter removably attached to a housing of a detection device in the event that an attachment mechanism of the communications adapter provides positive engagement of the communications adapter with the detection device;
communicating, with the communications adapter via the short-range wireless interface of the UE to obtain from a communications adapter, detection data indicating the presence of a substance of interest at the detection device;
providing the detection data to a remote device via a wide area network.

23. The method of claim 22 further comprising obtaining, from the communications adapter, an identifier of the detection device and providing the identifier to the remote device via the wide area network, for example wherein the identifier is provided with the detection data.

24. The method of claim 22 or 23, wherein the detection data is encrypted and the method comprises decrypting the detection data and providing, at the UE, a user alert in the event that the detection data indicates presence of a threat.

25. A computer program product comprising program instructions configured to program a processor of a communications adapter to perform the method of any of claims 18 to 21 and/or to program a UE perform the method of any of claims 22 to 24.
